(19) United States
(12) Patent Application Publication
(10) Pub. No.: US 2011/0288959 A1
(43) Pub. Date: Nov. 24, 2011

(54) METHOD FOR PROMOTING HYBRID CORE CONSTRUCTION

(76) Inventors: Shaun Faber, Santa Rosa, CA (US); Kevin Farrell, Santa Rosa, CA (US); Robert W O'Neel, Santa Rosa, CA (US); Clint Wilson, Santa Rosa, CA (US)

(21) Appl. No.: 12/782,978

(22) Filed: May 19, 2010

(51) Int. Cl. G06Q 50/00; G06F 17/50; G06F 3/048; G06Q 30/00; G06Q 90/00

(52) U.S. Cl. 705/27.1; 705/500; 715/738; 703/1

(57) ABSTRACT

A method of selling architectural plans as well as a modular core. The modular core constitutes all wet areas of a home including all of its kitchen and bathroom areas and supporting electrical and plumbing connections. A plurality of architectural plans are developed, each architectural plan including a plan for the construction of a stick built home which includes a modular core. The architectural plans are then provided to developers or homebuilders.

### TECHNICAL FIELD

The present invention is directed to a method of selling a modular core to be included with onsite stick built additions to those developers and homebuilders interested in fabricating a home which looks completely stick built and yet benefits from efficiencies which a modular core can provide. The modular core is defined as containing at least all of its kitchen and bathroom areas and their supporting electrical and plumbing connections which are built offsite and integrated with the stick built portions of the home onsite.

### BACKGROUND OF THE INVENTION

Modular homes have been available for many years and have provided a low cost alternative to traditional construction. While the quality of the interior amenities of modular homes has improved tremendously in recent times, they have always had a certain stigma attached to them due to the lack of aesthetic appeal particularly as to their exterior elevations, due in large part to the constraints imposed upon them by virtue of having to transport them to their designated land site. Traditionally, modular homes have also had the disadvantage of financing, usually as a result of lenders establishing comparative sales prices by referring to nearby mobile home parks.

The traditional custom home is stick built onsite. “Stick built” is an industry term for a home built on a designated land site and not a factory built home. All of the lumber is delivered onsite and most, if not all of the flaming is done onsite. The trades are called upon to the site to install cabinets, plumbing, heating, electrical connections and the like. As such, stick built is usually used when comparing a custom home to a factory built home. In fact the concept of a factory built home has not been very favorable, and oftentimes it creates the impression of having tires and axles under the home, in other words, the “trailer” concept. From the standpoint of cost and ease of construction, a factory built home has certain unique advantages over their stick built counterparts.

Producing a structure on a land site generally requires a plurality of inspectors not only for such things as the structure's foundation and the like but also for the structure's electrical and plumbing hookups which can oftentimes dramatically slow the project. Weather also creates issues during construction as does the need to hire and retain skilled subcontractors which may or may not always be available at times when their services are most needed. Coordinating subcontractors and integrating their services with favorable weather conditions oftentimes poses significant logistical issues which not only slows down construction but also can dramatically add to the overall cost of a project.

Others have recognized the potential benefits in constructing portions of a home offsite. For example, reference is made to U.S. Pat. No. 4,501,098, issued on Feb. 26, 1985. The '098 patent discusses the need to decrease labor and material costs while providing a custom look and feel to a home by taking advantage of methods of fabrication including constructing entire houses or portions of houses at a remote manufacturing facility. The patentee noted that off-site prefabrication methods take advantage of factory assembly line techniques to reduced labor costs of construction. Limiting on-site activities to assembly of preconstructed units, installation of mechanical and electrical systems and finishing work, results in costs savings.

The '098 patent also refers to U.S. Pat. No. 3,392,676 which shows a prefabricated mobile home-type construction comprising outside structural walls and a floor attached to steel I-beam chassis on which the unit is transported. The structure, including its chassis, is set upon a foundation at the building site after which the axle, wheels and trailer hitch are removed. The house is constructed around a prefabricated unit which is limited in configuration because it must specifically conform to the central modular portion, usually having bedrooms on one side and a living area on the other side of the unit. A similar disclosure can be found in U.S. Pat. No. 3,862,534.

The '098 patent discloses a method for constructing a house comprising building modular portions of the house structure off-site in a factory, transporting the modular sections to the building site, and positioning them on a foundation to substantially form the first level of a house. The modular sections are designed to provide those portions of the house which are non-expressive and which have standard elevations from the floor surface to ceiling. These modular portions of the house structure can be advantageously constructed through an assembly line technique in a factory of a size which meets highway size regulations, to obtain costs savings without sacrificing elements of character and originality and the completed house project. The modular house portions generally comprise the utility areas which include the kitchen and bathrooms and the slumber areas, which include most of the ordinary bedroom space, in addition to substantially all of the mechanical and electrical systems required for the house. After the modular portions are installed, the patentee teaches constructing the remainder of the house onsite to provide a custom look creating large living space areas of the home defining the volumetric room shapes which attract one's attention and provide visual identity to the home.

Although the invention taught in the '098 patent provides considerable cost savings over construction methods theretofore employed, the patented reference does not go far enough to suggest a protocol to maximize the benefits offsite modular construction integrated with onsite stick built features.

It is not uncommon to create a series of plans, architectural in nature, for developers and homebuilders as a means of choosing the appropriate design for a particular landsite. This is particularly commonplace when a developer is about to embark upon a multiunit subdivision where every attempt is made to individualize the homes and yet ensure that they all meet an appropriate theme or general design which fosters the look and feel of the subdivision at large.

Most architectural plans of this nature are of two types. The first of those deal with stick built homes fostering a custom look in keeping with the subdivision or community. An alternative would be plans for manufactured homes which lend themselves to a different class of buyer, and a community of limited economic means. However, Applicants recognize that packaging architectural plans which embrace the benefits of both modular core construction and stick built exteriors offer the benefits of both types of construction methods. Although not here before offered, Applicants have now recognized the benefits of providing multiple plans where different elevations are achievable fostering a stick built or custom look married to one or more modular cores enabling the developer or homebuilder to pick from a selected menu of options in fostering a custom look at a significantly reduced price.

### SUMMARY OF THE INVENTION

A method of selling architectural plans including one or more modular cores. Each modular core constitutes all wet areas of a home including all of its kitchen and bathroom areas and supporting electrical and plumbing connections. A plurality of architectural plans are developed, each architectural plan including a plan for the construction of a stick built home, each stick built home including a modular core. The architectural plans are then provided to developers or homebuilders.

### BRIEF DESCRIPTION OF THE FIGURES

FIG. 1 is a front elevational view of a typical structure built onsite with a modular core and stick built portions resulting in a custom look home.

FIG. 2 is a perspective view of the shell of a typical modular core fabricated in carrying out the present method.

FIG. 3 is a plan view of an architectural plan of a typical modular core and surrounding stick built elements having been designed pursuant to the method of the present invention.

FIG. 4 is a flow chart depicting the availability of the present invention online.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments in the invention are illustrated by way of example. It is to be expressly understood, however, that the drawings are for the illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

It should additionally be noted that the invention described and claimed in Applicant's pending U.S. application Ser. No. 12/782,954 filed on May 19, 2010 can be adopted and applied to the construction of any structure be it residential or commercial. For the sake of convenience, reference is made to a “home” throughout this disclosure connoting a private residence. However, the use of the designation “home” implying noncommercial construction is made strictly for convenience and the present invention and is not to be considered so limiting. Further, as will be quite apparent from the following disclosure, the thrust of the present invention involves the construction of a modular core having all plumbing or wet areas constructed off site. However, it should be understood that certain plumbing and supporting utilities that oftentimes are located remotely from a centralized core area can still be installed on site and outside the modular core while remaining within the spirit and scope of the present invention. Such might include water heaters and washer/dryers that might be housed in a garage and a furnace which typically is not situated in a wet area.

Typical home construction consists of designating a land site upon which a foundation is established. Skilled contractors and subcontractors are brought to the site to erect the home consistent with its architectural renderings.

In an attempt to reduce costs, modular homes have been created offsite built both “on frame” as well as “off flame”. On frame modular homes are built on a permanent chassis while off frame modulars are built with removal of the chassis frame in mind. An off frame modular usually requires additional cranes to assist with home placement. In either case, the final product does not have the look or feel of a stick built home and many local ordinances discourage the use of modular homes in certain residential areas as they do not lend themselves to an upscale community. Nevertheless, there are certain advantages in being able to produce a home using modular construction as there are cost efficiencies inherent in the controlled environment employed in building modular homes. For example, there are less administrative costs. Fewer subcontractors are involved in the building process enabling a builder to more readily control costs.

The invention presented in Applicant's copending U.S. application Ser. No. 12/782,954 filed on May 19, 2010 is intended to enable one to achieve the majority of benefits inherent in modular construction while achieving the look and feel of a stick built product.

The above goals are achievable in practicing the method described previously. Specifically, a modular core of the home is built offsite and delivered to the home site and secured to a foundation located thereon. The modular core is defined as all wet areas of the home including all of its kitchen and bathroom areas and their supporting electrical and plumbing connections. The modular core includes all supporting structure such as kitchen and bathroom cabinetry and typical features found in such areas. The stick portions of the home are built on the land site to be integrated with the modular core which together comprise the entirety of the home.

In carrying out this method, reference is made first to FIG. 1. FIG. 1 illustrates a somewhat typical architecturally created floor plan 10 intending to include kitchen 16, laundry 17, master bath 18, additional bathes 19 and 20 as well as master bedroom 21, secondary bedrooms 25 and 26, den/bedroom 24, entry 23, great room 22 and garage 28. In keeping with the present invention, modular core 15 has been created offsite containing all wet areas, and preferably only wet areas, including kitchen 16, laundry 17, master bath 18, and additional bathes 19 and 20. Included within modular core 15 are the supporting electrical and plumbing connections for these wet areas. Furthermore, as noted previously, laundry 17 could be located outside of the modular core, such as in the garage while keeping within the scope of the present invention.

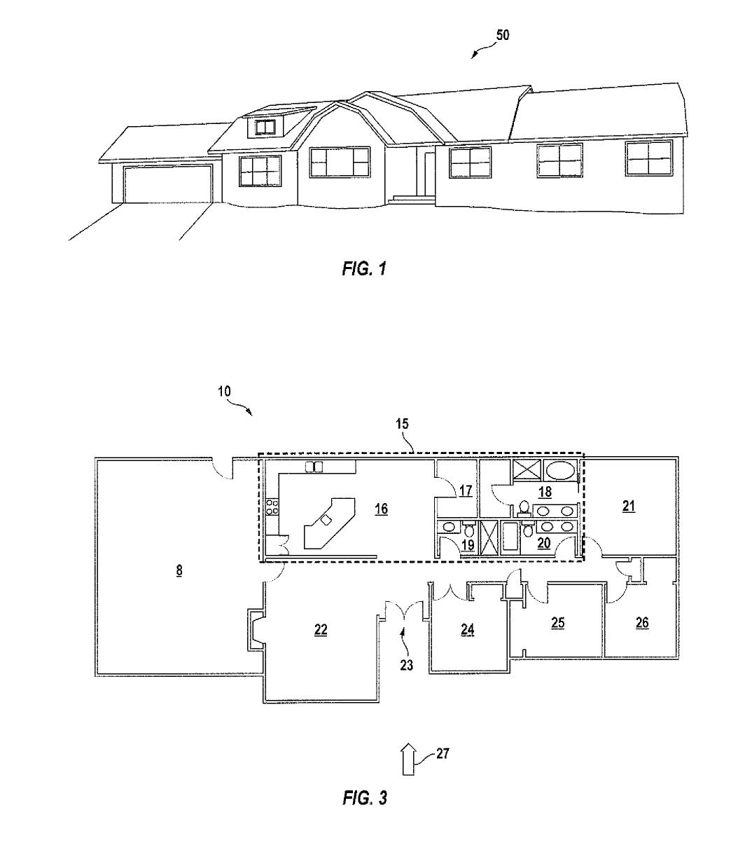

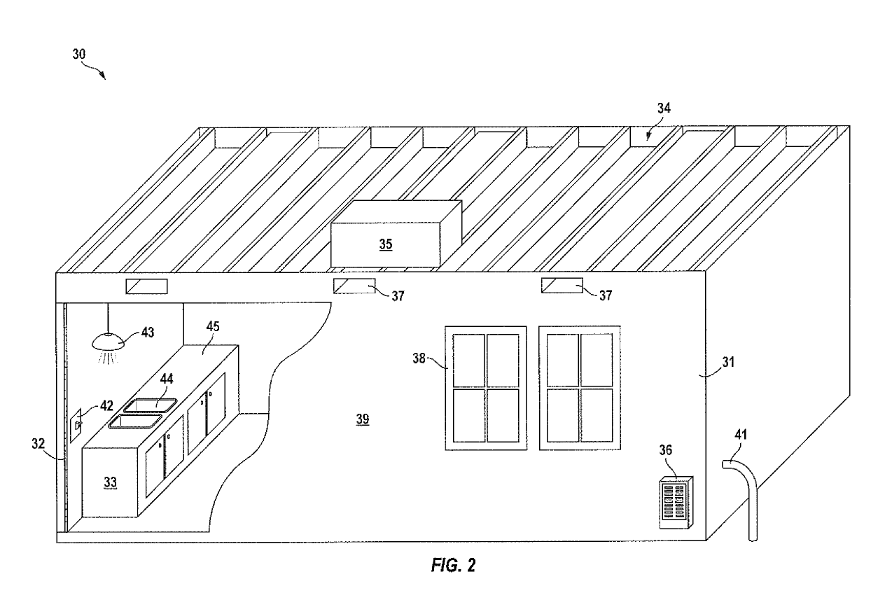

As noted, core 15 is produced in a factory offsite and later transported to the eventual home site of interest. The modular structure, shown for example in FIG. 2 as modular core 30 is constructed according to the Uniform Building Code for houses. This requires conventional construction identical to construction typically performed on-site at a building location. The modular core, as a consequence, is intended to integrate within the total house shown in FIG. 3 as an example to provide the look of a custom residence built completely onsite.

Turning again to FIG. 2, it is intended that modular core 30 is fully sided by, for example, cementious hardboard 31. The modular core should also be finished with drywall 32 having its cabinets 33 fully in place thus supporting the various kitchen and bathroom fixtures such as sink 44, countertop 45, electrical switches 42 and light fixtures 43 prior to installation of modular core 30 onto the building site.

Mechanical system 35 can be placed atop core 30, such as the heating and air conditioning facility, again, installed at the same factory which fabricated modular core 30 and placed upon rafters 34. Electrical service 36 and plumbing 41 can interface with modular core 30 noting that the wiring and duct work 37 is again fabricated off site to maximize the economies of factory construction. Finally, windows 38 can also be fully installed in instances where front wall 39 of modular core 30 is intended to access and be part of the exterior wall of the final home to be constructed. In this instance, one could even install finishing facie such as shingles and the like on wall 39 to again maximize the economies of factory construction. An attic can be built on site about mechanical system 35 and a roof, including trusses when necessary, also can be applied on site atop the attic.

It should be quite apparent from consideration of the previous disclosure that it is the intent of the invention described in Applicant's copending U.S. application Ser. No. 12/782,954 filed on May 19, 2010 to maximize the economies of factory construction in any and all possible ways. Again, all wet areas and their supporting electrical and ducting are installed as well as fixtures to support the kitchen and bathroom areas in a core which has been finished by sheetrock and fully sided. Thus, although others have suggested partial offsite construction, no one to date has driven the economies of factory built cores to the extent now suggested herein.

It is quite apparent hum the above discussion, the economies of providing a modular core together with stick built portions of an architectural plan are exceedingly compelling. In order to foster adoption, Applicant has provided a method of selling a modular core and architectural plans embracing a modular core to developers and homebuilders. This is ideally accomplished by providing a plan book containing a plurality of architectural plans, each architectural plan comprising a plan for the construction of a stick built home in which each of the stick built homes comprise a modular core. The recipient of such plans can then select a modular core that would properly integrate with the architectural plans of a stick built elevation and floor plan to thus achieve the appropriate overall architectural plan and rendering suitable for a particular landsite. For example, in reference to FIGS. 1 and 3, a suitable architectural plan would show the elevation of FIG. 1 together with the floor plan of FIG. 3. The modular core identified by the highlighted area 15 would be shown to be appropriate for fitting into the remaining stick built portions as described above. In most instances, a plurality of elevational views (FIG. 1) and a plurality of floor plans (FIG. 3) could be integrated with a single modular core 15 providing the recipient of the architectural plan a plurality of stick built options while taking advantage of the economics of using the modular core portion 15 therein.

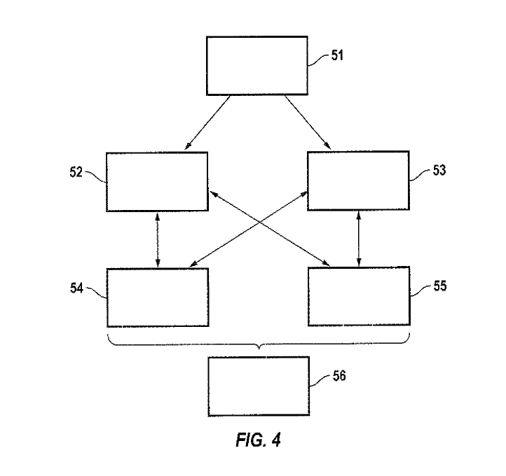

All of the description of the present invention noted above can be accomplished in paper copy through the use of an appropriate plan book. Alternatively, one could provide such information online and make the experience interactive to enable a developer or homebuilder to choose an architectural rendering including its stick built portions from one column and a core from another column which the creator of the website has determined are compatible for integration within one another. In this regard, reference is made to FIG. 4.

Turning to FIG. 4, one wishing to engage in the present method online, over the Internet, would first access field 51 containing a library of for example, elevational views. Once the appropriate look and feel of a home has been selected, choices 52 and 53 (or more) can be accessed including, for example, as appropriate limiting fields, the number of bedrooms, bathrooms, whether the floor plan calls for a one story or two story elevation, etc. Interactive with this process would be providing modular cores 54 and 55 which may or may not be compatible with the elevation selected in fields 52 and 53. Once a suitable match has been made between the elevational or stick built portions 52 and 53 and the modular core portions 54 and 55, the user would be provided with field of suitable combinations in field 56. In summary, a user would first decide upon the appropriate look and feel of the stick built architectural rendering. Fields could be accessed, such as number of bedrooms, approximate square feet, whether the home is to have a single story or multiple stories and similar considerations. As selections are made, plan views can be selected and appropriate modular cores determined to be compatible. The final plan is then presented in field 56 which could include pricing where appropriate.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes in equivalence will readily occur to those skilled in the art and may be employed as suitable, without departing from the true spirit and scope of the invention. Such changes might involve alternative materials, components, structural arrangements, sizes, shapes, forms, functions, operational features or the like. Therefore, the description and illustration should not be considered as limiting the scope of the invention, which is defined by the appended claims.

What is claimed is:

1. A method of selling a modular core constituting all wet areas of a home including all of its kitchen and bathroom areas and their supporting electrical and plumbing connections, said method comprising developing a plurality of architectural plans, each architectural plan comprising a plan for the construction of stick built homes in which each stick built home comprises said modular core and supplying said architectural plans to developers or homebuilders.

2. The method of claim 1 wherein a plurality of said architectural plans employ a singular modular core.

3. The method of claim 1 further comprising the manufacture and sale of at least one modular core to the recipient of said architectural plans.

4. The method of claim 1 wherein said architectural plans are made available to developers and homebuilders online or over the Internet.

5. A method of selling architectural plans for home construction, said architectural plans including at least one modular core constituting all wet areas of said home including all of its kitchen and bathroom areas and their supporting electrical and plumbing connections, said method comprising developing a plurality of such architectural plans, each architectural plan comprising a plan for the construction of a stick built home including said modular core and supplying said architectural plans to developers or homebuilders.

6. The method of claim 5 wherein said architectural plans are made available to developers and homebuilders online over the Internet.

7. The method of claim 6 wherein said Internet site is in interactive enabling a viewer to match stick built home features with at least one modular core.

8. The method of claim 5 wherein said plurality of architectural plans comprise a plurality of stick built features and a plurality of modular cores some of which can be mixed and matched together to enable one to employ a modular core with more than one stick built plan.
